(19) United States
(12) Patent Application Publication
(10) Pub. No.: US 2011/0075829 A1
(43) Pub. Date: Mar. 31, 2011

(54) METHOD AND APPARATUS FOR CONTROLLING A CONFERENCE BRIDGE

(75) Inventors: Stuart O. Goldman, Scottsdale, AZ (US); Karl F. Rauscher, Emmaus, PA (US)

(73) Assignee: ALCATEL-LUCENT USA INC., Murray Hill, NJ (US)

(21) Appl. No.: 12/570,491

(22) Filed: Sep. 30, 2009

(51) Int. Cl. H04M 3/42

(52) U.S. Cl. 379/202.01

(57) ABSTRACT

A method for controlling a conference bridge may include: a) establishing status information for a conference call and storing the status information in a storage device, the status information for maintaining a participant status for user devices; b) setting the status information to indicate user devices participating in the conference call are connected; c) transmitting a unique identifier to each user device via an in-band signal; d) receiving a line-on-hold signal and the corresponding unique identifier from at least one user device, the line-on-hold signal being an in-band signal; and e) updating the status information in response each line-on-hold signal received to indicate the corresponding user device has placed the conference call on hold. An apparatus for may include a storage device for storing the status information, a processor, a transmitting device for transmitting the unique identifier, and a receiving device for receiving the line-on-hold signal.

### BACKGROUND

This disclosure relates to a method and apparatus for controlling a conference bridge while a conference call is connected by providing a hold status feature. While this disclosure describes exemplary embodiments of the hold status feature using in-band signaling, and will be thus described with specific reference thereto, it will be appreciated that the disclosed concepts may have usefulness in collecting and providing other types of status information associated with the participants of a conference call to one or more of the participants during the call.

By way of background, conference bridges provide a multi-party conference call service that enables multiple parties on different user devices to participate in a single call. There are various ways to initiate the conference call and to connect the parties. There are also various ways to add a party to the conference call. Once connected to a conference call, a user device may remain connected to the call until the conference call is ended, place the conference call on hold, return to the conference call by deactivating the hold, or terminate the conference call.

The hold function may be activated and deactivated manually, such as by a user pressing a hold control. Additionally, use of other features on a user device may activate and deactivate the hold function automatically, such as switching lines to respond to an incoming call or switching lines to place an outgoing call.

A problem is created when a user device places the conference call on hold because the other parties are not notified that the user device is on hold and the conversation may continue among the other parties as if the party on hold is still participating. The other parties may learn that the party is on hold if there is no response to a question or if there is no reply or comment from the party when one is expected.

For example, a user device may place the conference call on hold so that the party can take a call on another line (e.g., answer a call waiting tone). The party going on hold may not have time to notify the other parties of the hold. Moreover, it may be rude to interrupt conversation during the conference call in order to notify the other parties before the call on the other line stops ringing.

There are many other circumstances during a conference call that may require a party to place the conference call on hold. For example, the party may need to place a call on another line or to attend to another matter that requires immediate attention. Alternatively, the party may simply want to activate the hold function in order to ensure privacy for another matter from the conference call.

Based on the foregoing, a solution that collects hold status information for a user device participating in a conference call and provides the status information to one or more participants during the conference call is desirable. Additionally, a solution that provides a hold status feature that is compatible with existing wireless, wire line, and voice over internet protocol (VoIP) networks and existing user devices is desirable.

### SUMMARY

In one aspect, a method for controlling a conference bridge is provided. In one embodiment, the method includes: a) establishing status information for a conference call and storing the status information in a storage device, a plurality of user devices connected to the conference call via a communication network, the status information for maintaining a participant status for one or more user devices participating in the conference call; b) initially setting the status information to indicate each user device participating in the conference call is connected; c) transmitting a unique identifier to each user device participating in the conference call, wherein the unique identifier is transmitted via an in-band signal with respect to the conference call; d) receiving a line-on-hold signal and the corresponding unique identifier from at least one user device participating in the conference call, wherein the line-on-hold signal is an in-band signal with respect to the conference call; and e) updating the status information in response to receiving each line-on-hold signal to indicate the corresponding user device from which the corresponding line-on-hold signal was received has placed the conference call on hold.

In another aspect, an apparatus for controlling a conference bridge is provided. In one embodiment, the apparatus includes: a storage device for storing status information for a conference call, a plurality of user devices connected to the conference call via a communication network, the status information for maintaining a participant status for one or more user devices participating in the conference call; a processor for controlling a conference call and, in operative communication with the storage device, for establishing the status information and initially setting the status information to indicate each user device participating in the conference call is connected; a transmitting device in operative communication with the processor for transmitting a unique identifier to each user device participating in the conference call, wherein the unique identifier is transmitted via an in-band signal with respect to the conference call; and a receiving device in operative communication with the processor for receiving a line-on-hold signal and the corresponding unique identifier from at least one user device participating in the conference call, wherein the line-on-hold signal is an in-band signal with respect to the conference call. In this embodiment, the processor updates the status information in response to receiving each line-on-hold signal to indicate the corresponding user device from which the corresponding line-on-hold signal was received has placed the conference call on hold.

In yet another aspect, a method for controlling a conference bridge is provided. In one embodiment, the method includes: a) receiving a unique identifier at a user device participating in a conference call from a bridge controller via a communication network, wherein the unique identifier is received via an in-band signal with respect to the conference call, the unique identifier uniquely identifying the user device as a participant of the conference call in relation to other user devices participating in the conference call; b) determining the user device is about to activate a hold function in relation to the conference call; c) transmitting a line-on-hold signal and the unique identifier from the user device to the bridge controller in response to the determining in b), wherein the line-on-hold signal is an in-band signal with respect to the conference call; and d) placing the conference call on hold at the user device after the line-on-hold signal is transmitted.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a flow chart of an exemplary embodiment of a process for controlling a conference bridge;

FIG. 2 is a block diagram of an exemplary embodiment of an system for controlling a conference bridge;

FIG. 3 is a flow chart of another exemplary embodiment of a process for controlling a conference bridge;

FIG. 4 is a block diagram of another exemplary embodiment of an system for controlling a conference bridge;

FIG. 5, is a call flow diagram of an exemplary embodiment of signaling for controlling a conference bridge in conjunction with any of FIGS. 1-4;

FIG. 6, is a diagram of an exemplary embodiment of status information collected or provided in controlling a conference bridge in conjunction with any of FIGS. 1-4.

### DETAILED DESCRIPTION

Various embodiments of methods and systems for controlling a conference bridge are described herein. For example, a bridge controller may be adapted to implement techniques for controlling the conference bridge while maintaining compatibility with existing wireless, wire line, and voice over internet protocol (VoIP) networks. Additionally, a user device may be adapted to implement techniques for controlling the conference bridge while maintaining compatibility with existing wireless wire line and VoIP networks Likewise a computer device may be adapted to implement techniques for controlling the conference bridge while maintaining compatibility with existing internet protocol (IP) networks. While various exemplary bridge controllers, user devices, and computer devices are identified herein, the techniques for controlling a conference bridge can be applied to any corresponding bridge controller, user device, and computer device without disrupting its compatibility with existing communication networks, data networks, user devices, and computer devices.

In one embodiment, a bridge controller connects a conference call between multiple user devices through a conference bridge. After each user device is accepted as a participant and connected to the conference call via the conference bridge, the bridge controller sends a unique value to the corresponding user device for the conference call. The unique value, for example, may indicate a port number of the conference bridge through which the corresponding user device is connected. The values may be one (1) for the first participant, two (2) for the next participant, etc. The unique value also notifies the user devices that the bridge controller has a hold status feature activated for the conference call. User devices that have the hold status feature activated for the conference call may store the unique value for use during the call. User devices that do not have the hold status feature activated for the conference call may simply ignore the unique value and continue to participate in the conference call normally.

When a user device participating in the conference call that has the hold status feature activated starts to invoke a hold, if the corresponding user device has received a port number from the bridge controller (i.e., indicating that it is attached to a bridge and the bridge has this capability), the user device will send a brief in-band tone message with the port number indicating it has initiated the hold for the conference call. The bridge controller detects the hold message and is aware that the user device has placed the conference call on hold. After the user device takes the conference call off hold, the user device sends the hold message again or sends a different in-band tone message to the bridge controller indicating the user device has returned to the conference call.

The bridge controller is connected to the conference call and monitors the call for in-band messages. The hold status feature detects the in-band messages and maintains status information for the conference call based on the corresponding hold status changes. The status information includes the hold status of each user device participating in the call that has the hold status feature activated. For example, the status information for the conference call can use the caller ID name and number received by the bridge controller at set up and call acceptance to identify the parties (i.e., user devices) participating in the conference call. Backward compatibility is provided because user devices that do not have the hold status feature activated will just not provide in-band signals regarding their hold status, but can fully participate in the conference call via the conference bridge. The hold status feature can be extended to additional user devices that are joined to the conference call via outcalls from the bridge controller or from the user device of a current participant.

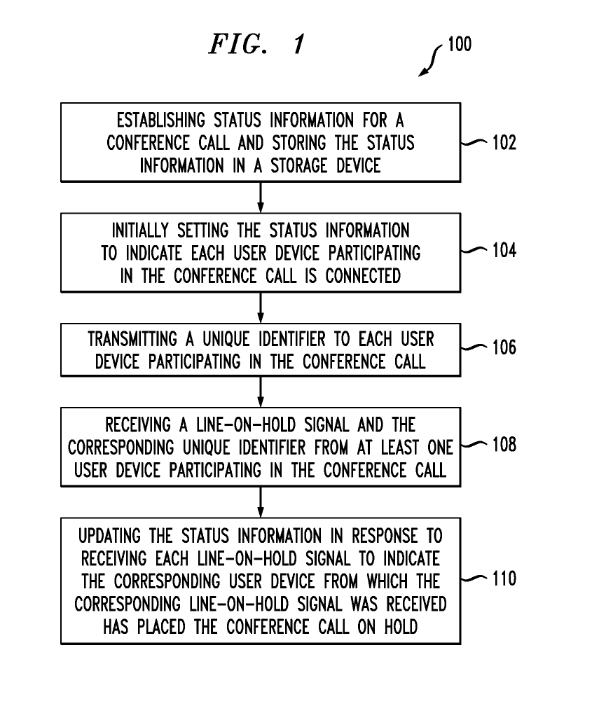

Referring now to the drawings wherein the showings are for purposes of illustrating the exemplary embodiments only and not for purposes of limiting the claimed subject matter, FIG. 1 depicts an exemplary embodiment of a process 100 for controlling a conference bridge that begins at 102 where status information for a conference call may be established and stored in a storage device. Multiple user devices may be connected to the conference call via a communication network. The status information may maintain a participant status for one or more user devices participating in the conference call.

At 104, the status information may initially be set to indicate each user device participating in the conference call is connected. Next, a unique identifier may be transmitted to each user device participating in the conference call (106). The unique identifier may be transmitted via an in-band signal with respect to the conference call.

At 108, a line-on-hold signal and the corresponding unique identifier may be received from at least one user device participating in the conference call. The line-on-hold signal may be an in-band signal with respect to the conference call. Next, the status information may be updated in response to receiving each line-on-hold signal to indicate the corresponding user device from which the corresponding line-on-hold signal was received has placed the conference call on hold (110).

In another embodiment, the process 100 may also include receiving a line-off-hold signal and the corresponding unique identifier from at least one user device participating in the conference call from which the line-on-hold signal was received. The line-off-hold signal may be an in-band signal with respect to the conference call. In this embodiment, the status information may be updated in response to receiving each line-off-hold signal to indicate the corresponding user device from which the corresponding line-off-hold signal was received has returned to the conference call.

In the embodiment being described, the process 100 may further include transmitting a line-off-hold acknowledgment and the corresponding unique identifier to each user device from which the line-off-hold signal was received to acknowledge the corresponding line-off-hold signal was received. The line-off-hold acknowledgment may be transmitted via an in-band signal with respect to the conference call.

In yet another embodiment, the process 100 may also include receiving a login request from a computer device via a data network. In this embodiment, the status information may be provided to the computer device via the data network for display to a user on a display device. The status information may be transmitted to the computer device or retrieved by the computer device after the login request is processed. The initial status information on the display device may be periodically refreshed or updated either manually (e.g., user refresh activated) or automatically. Automatic updates to the status information on the display device may be based on a refresh rate (e.g., time) or on a change to the status information (e.g., hold status change).

In the embodiment being described, the user may be participating in the conference call. The corresponding user device for the user and the computer device may be disposed such that the user can monitor participant status on the display device of the computer device while participating in the conference call via the corresponding user device. The user may be an initiator of the conference call. Alternatively, the user may be any participant of the conference call. Moreover, multiple participants may be provided with the status information via multiple corresponding computer devices. The status information may be provided to the computer device via a web page. Alternatively, the status information may be provided to the computer device via any suitable means.

In the embodiment being described, the process 100 may also include authenticating the login request from the computer device to confirm the computer device is authorized to receive the status information for the conference call. The authentication may include password checks, subscriber privilege checks, and other security checks. In this embodiment, a login acknowledgment may be transmitted to the computer device via the data network after the authenticating is successfully completed. The login acknowledgment may indicate the login request was received and the computer device is authorized access to the status information.

In the embodiment being described, the data network may include an IP network, such as the Internet. The computer device and the corresponding user device may be combined in a communication device, such as a smart phone or an IP phone. The computer device may be remote in relation to the storage device in which the status information is stored.

In still yet another embodiment, the process 100 may also include receiving an acknowledgment signal and the corresponding unique identifier from at least one user device participating in the conference call. The acknowledgment signal may be an in-band signal with respect to the conference call. The acknowledgement signal may indicate the corresponding user device has a hold status feature activated for the conference call. In this embodiment, the status information may be updated in response to receiving each acknowledgement signal to indicate the corresponding user device from which the corresponding acknowledgment signal was received has a hold status feature activated for the conference call.

In another embodiment, the process 100 may also include transmitting a line-on-hold acknowledgment and the corresponding unique identifier to each user device from which the line-on-hold signal was received to acknowledge the corresponding line-on-hold signal was received. The line-on-hold acknowledgment may be transmitted via an in-band signal with respect to the conference call.

The communication network may include a wireless communication network, a wire line communication network, a VoIP network, or any suitable combination of such networks. The unique identifier may relate to a port number assigned to the corresponding user device for the conference call.

Each in-band signal described in relation to FIG. 1 may include a pulse tone, a frequency tone, a multi-frequency tone, or any suitable combination of such tones. The various embodiments of the process 100 described above may be implemented in a bridge controller or any suitable component of the communication network.

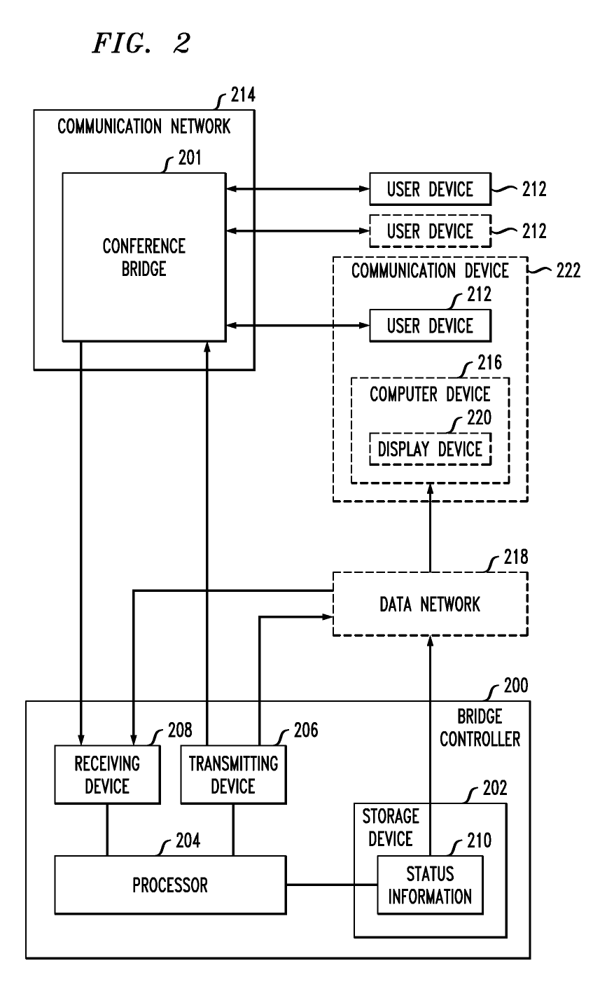

With reference to FIG. 2, an exemplary embodiment of a bridge controller 200 in a system for controlling a conference bridge 201 may include a storage device 202, a processor 204, a transmitting device 206, and a receiving device 208. The storage device 303 may store status information 210 for a conference call. Multiple user devices 212 may be connected to the conference call a via a communication network 214. The status information 210 may maintain a participant status for one or more user devices 212 participating in the conference call. The processor 204 may control the conference call. The processor 204, being in operative communication with the storage device 202, may establish the status information 210 and may initially set the status information 210 to indicate each user device 212 participating in the conference call is connected.

The transmitting device 206, being in operative communication with the processor, may transmit a unique identifier to each user device 212 participating in the conference call. The unique identifier may be transmitted via an in-band signal with respect to the conference call. The receiving device 208, being in operative communication with the processor, may receive a line-on-hold signal and the corresponding unique identifier from at least one user device 212 participating in the conference call. The line-on-hold signal may be an in-band signal with respect to the conference call. The processor 204 may update the status information in response to receiving each line-on-hold signal to indicate the corresponding user device 212 from which the corresponding line-on-hold signal was received has placed the conference call on hold.

In another embodiment, the receiving device 208 may receive a line-off-hold signal and the corresponding unique identifier from at least one user device 212 participating in the conference call from which the line-on-hold signal was received. The line-off-hold signal may be an in-band signal with respect to the conference call. In this embodiment, processor 208 may update the status information 210 in response to receiving each line-off-hold signal to indicate the corresponding user device 212 from which the corresponding line-off-hold signal was received has returned to the conference call.

In the embodiment being described, the transmitting device 206 may transmit a line-off-hold acknowledgment and the corresponding unique identifier to each user device 212 from which the line-off-hold signal was received to acknowledge the corresponding line-off-hold signal was received. The line-off-hold acknowledgment may be transmitted via an in-band signal with respect to the conference call.

In yet another embodiment, the receiving device 208 may receive a login request from a computer device 216 via a data network 218. In this embodiment, the processor 204 may provide the status information 210 to the computer device 216 via the data network 218 for display to a user on a display device 220. The status information 210 may be transmitted to the computer device 216 or retrieved by the computer device 216 after the login request is processed. The initial status information 210 on the display device 220 may be periodically refreshed or updated either manually (e.g., user refresh activated) or automatically. Automatic updates to the status information 210 on the display device 220 may be based on a refresh rate (e.g., time) or on a change to the status information 210 (e.g., hold status change).

In the embodiment being described, the user may be participating in the conference call. The corresponding user device 212 for the user and the computer device 212 may be disposed such that the user can monitor participant status on the display device 220 of the computer device 216 while participating in the conference call via the corresponding user device 212. The user may be an initiator of the conference call. Alternatively, the user may be any participant of the conference call. Moreover, multiple participants may be provided with the status information 210 via multiple corresponding computer devices 216. The status information 210 may be provided to the computer device 216 via a web page. Alternatively, the status information 210 may be provided to the computer device 216 via any suitable means.

In the embodiment being described, the processor 204 may authenticate the login request from the computer device 216 to confirm the computer device 216 is authorized to receive the status information 210 for the conference call. The authentication may include password checks, subscriber privilege checks, and other security checks. The transmitting device 206 may transmit a login acknowledgment to the computer device 216 via the data network 218 after the authenticating is successfully completed. The login acknowledgment may indicate the login request was received and the computer device 216 is authorized access to the status information 210.

In the embodiment being described, the data network 218 may include an IP network, such as the Internet. The computer device 216 and the corresponding user device 212 may be combined in a communication device 222, such as a smart phone or an IP phone. The computer device 216 may be remote in relation to the storage device 202 in which the status information 210 is stored.

In still yet another embodiment, the receiving device 208 may receive an acknowledgment signal and the corresponding unique identifier from at least one user device 212 participating in the conference call. The acknowledgment signal may be an in-band signal with respect to the conference call. The acknowledgment signal may indicate the corresponding user device has a hold status feature activated for the conference call. In this embodiment, the processor 204 may update the status information 210 in response to receiving each acknowledgement signal to indicate the corresponding user device 212 from which the corresponding acknowledgment signal was received has a hold status feature activated for the conference call.

In another embodiment, the transmitting device 206 may transmit a line-on-hold acknowledgment and the corresponding unique identifier to each user device 212 from which the line-on-hold signal was received to acknowledge the corresponding line-on-hold signal was received. The line-on-hold acknowledgment may be transmitted via an in-band signal with respect to the conference call.

The communication network 214 may include a wireless communication network, a wire line communication network, a VoIP network, or any suitable combination of such networks. The unique identifier may relate to a port number assigned to the corresponding user device 212 for the conference call.

Each in-band signal described in relation to FIG. 2 may include a pulse tone, a frequency tone, a multi-frequency tone, or any suitable combination of such tones. The bridge controller 200, although shown outside the communication network 214, may be a component of the communication network 214. The various embodiments of the bridge controller 200 described above may also be implemented in any other suitable component of the communication network 214.

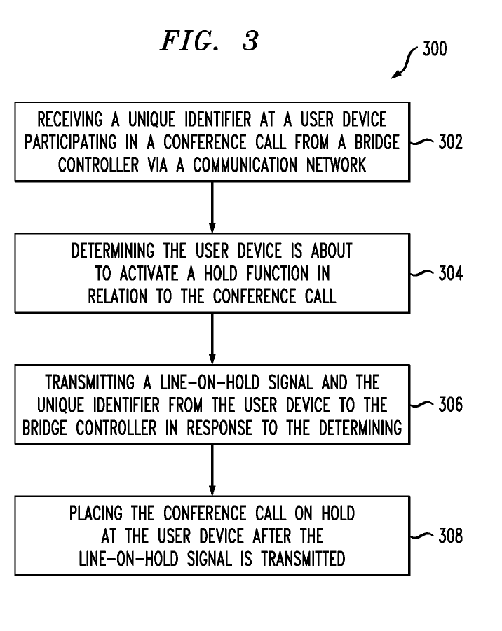

With reference to FIG. 3, an exemplary embodiment of a process 300 for controlling a conference bridge begins at 302 where a unique identifier may be received at a user device participating in a conference call from a bridge controller via a communication network. The unique identifier may be received via an in-band signal with respect to the conference call. The unique identifier may uniquely identify the user device as a participant of the conference call in relation to other user devices participating in the conference call.

At 304, it may determined that the user device is about to activate a hold function in relation to the conference call. Next, a line-on-hold signal and the unique identifier may be transmitted from the user device to the bridge controller in response to the determining in 304 (306). The line-on-hold signal may be an in-band signal with respect to the conference call. At 308, the conference call may be placed on hold at the user device after the line-on-hold signal is transmitted.

In another embodiment, the process 300 may also include transmitting a line-off-hold signal and the unique identifier from the user device to the bridge controller in response to the user device de-activating the hold function and returning the user device to the conference call. The line-off-hold signal may be an in-band signal with respect to the conference call.

In the embodiment being described, the process 300 may further include receiving a line-off-hold acknowledgment and the unique identifier from the bridge controller. The line-off-hold acknowledgment may be received via an in-band signal with respect to the conference call.

In yet another embodiment, the process 300 may also include transmitting a login request from a computer device to the bridge controller via a data network. In this embodiment, the process 300 continues with receiving status information for the conference call from the bridge controller via the data network for display to a user on a display device. The status information may maintain a participant status for one or more user devices participating in the conference call. The status information may be received via a transmission to the computer device or retrieved by the computer device after the login request is processed by the bridge controller. The initial status information on the display device may be periodically refreshed or updated either manually (e.g., user refresh activated) or automatically. Automatic updates to the status information on the display device may be based on a refresh rate (e.g., time) or on a change to the status information (e.g., hold status change).

In the embodiment being described, the user may be participating in the conference call via the user device. The user device and the computer device may be disposed such that the user can monitor participant status on the display device of the computer device while participating in the conference call via the user device. The user may be an initiator of the conference call. Alternatively, the user may be any participant of the conference call. The status information may be received at the computer device via a web page. Alternatively, the status information may be received at the computer device via any suitable means.

In the embodiment being described, the process may also include receiving a login acknowledgment from the bridge controller via the data network. The login acknowledgment may indicate the login request was authenticated by the bridge controller and the computer device is authorized access to the status information. The authentication may include password checks, subscriber privilege checks, and other security checks.

In the embodiment being described, the data network may include an IP network, such as the Internet. The computer device and the user device may be combined in a communication device, such as a smart phone or an IP phone. The computer device may be remote in relation to the bridge controller.

In still yet another embodiment, the process 300 may also include transmitting an acknowledgment signal and the unique identifier from the user device to the bridge controller in response to receiving the unique identifier. The acknowledgment signal may be an in-band signal with respect to the conference call. The acknowledgment signal may indicate the user device has a hold status feature activated for the conference call.

The communication network may include a wireless communication network, a wire line communication network, a VoIP network, or any suitable combination of such networks. The unique identifier may relate to a port number assigned to the user device for the conference call.

In one embodiment, the process 300 may also include storing the unique identifier in a storage device for reference by the user device during the conference call in conjunction with transmitting and receiving various in-band signals associated with a hold status feature. In another embodiment, the determining in 304 may be based on determining user activation of a hold control has occurred, determining user activation of a switching control to switch an active line from a first line to which the conference call is connected to another line, or user activation of another function of the user device that causes the conference call to be placed on hold has occurred.

Each in-band signal described in relation to FIG. 3 may include a pulse tone, a frequency tone, a multi-frequency tone, or any suitable combination of such tones. The various embodiments of the process 300 described above may be implemented in a user device, such as a mobile station, a wire line telephone, a VoIP device, or any other suitable communication device. Similarly, the various embodiments of the bridge controller described above may be implemented in any other suitable component of the communication network.

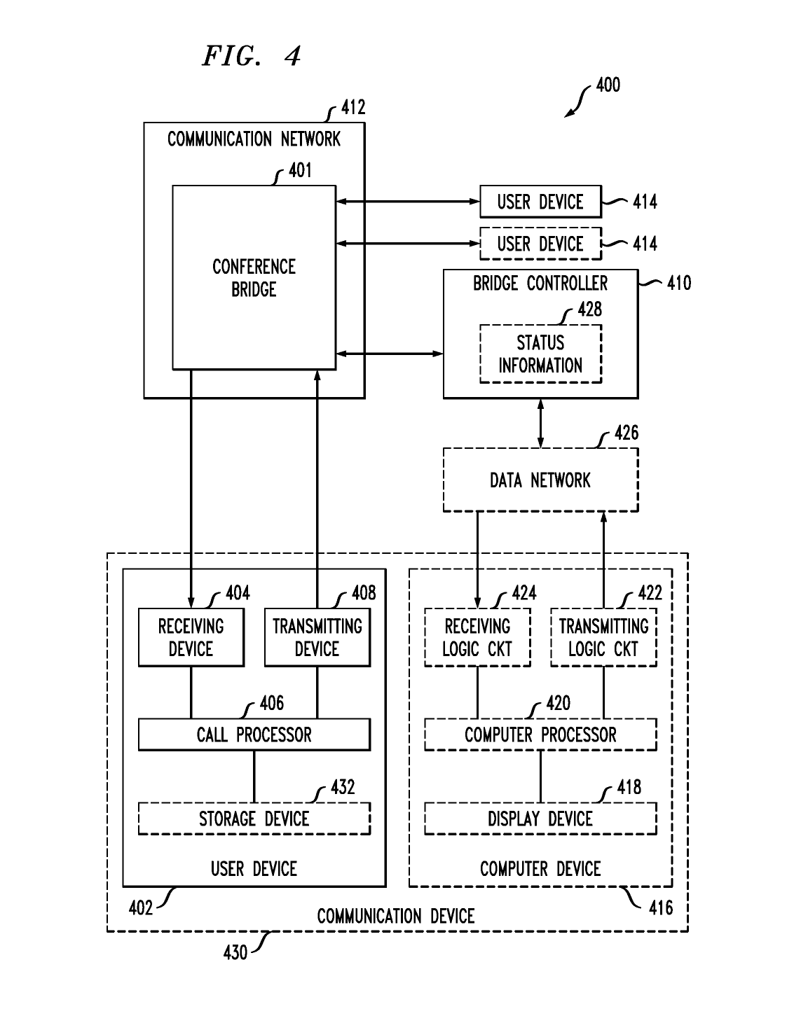

With reference to FIG. 4, an exemplary embodiment of a system 400 for controlling a conference bridge 401 may include a user device 402 for participating in a conference call. An exemplary embodiment of the user device 402 may include a receiving device 404, a call processor 406, and a transmitting device 408. The receiving device 404 may receive a unique identifier from a bridge controller 410 via a communication network 412. The unique identifier may be received via an in-band signal with respect to the conference call. The unique identifier may uniquely identify the user device 402 as a participant of the conference call in relation to other user devices 414 participating in the conference call.

The call processor 406, in operative communication with the receiving device, may control the user device 402, including determining the user device 402 is about to activate a hold function in relation to the conference call. The transmitting device 408, in operative communication with the call processor, may transmit a line-on-hold signal and the unique identifier to the bridge controller 410 in response to the call processor 406 determining the user device 402 is about to activate a hold function. The line-on-hold signal may be an in-band signal with respect to the conference call. The call processor 406 may place the conference call on hold after the line-on-hold signal is transmitted.

In another embodiment, the transmitting device 408 may transmit a line-off-hold signal and the unique identifier to the bridge controller 410 in response to the call processor 406 de-activating the hold function and returning the user device 402 to the conference call. The line-off-hold signal may be an in-band signal with respect to the conference call.

In the embodiment being described, the receiving device 404 may receive a line-off-hold acknowledgment and the unique identifier from the bridge controller 410. The line-off-hold acknowledgment may be received via an in-band signal with respect to the conference call.

In yet another embodiment, the 400 system may also include a computer device 416. An exemplary embodiment of the computer device 416 may include a display device 418, a computer processor 420, a transmitting logic circuit 422, and a receiving logic circuit 424. The computer processor 420, in operative communication with the display device 418, transmitting logic circuit 422, and receiving logic circuit 424, may control the computer device 416. The transmitting logic circuit 422 may transmit a login request to the bridge controller 410 via a data network 426. The receiving logic circuit 424 may receive status information 428 for the conference call from the bridge controller 410 via the data network 426 for display to a user on the display device 418. The status information may maintain a participant status for one or more user devices 402, 414 participating in the conference call. The status information may be received via a transmission to the computer device or retrieved by the computer device after the login request is processed by the bridge controller. The initial status information on the display device may be periodically refreshed or updated either manually (e.g., user refresh activated) or automatically. Automatic updates to the status information on the display device may be based on a refresh rate (e.g., time) or on a change to the status information (e.g., hold status change).

In the embodiment being described, the user may be participating in the conference call via the user device 402. The user device 402 and the computer device 416 may be disposed such that the user can monitor participant status on the display device 418 while participating in the conference call via the user device 402. The user may be an initiator of the conference call. Alternatively, the user may be any participant of the conference call. The status information 428 may be received at the computer device 416 via a web page. Alternatively, the status information 428 may be received at the computer device 416 via any suitable means.

In the embodiment being described, the receiving logic circuit 424 may receive a login acknowledgment from the bridge controller 410 via the data network 426. The login acknowledgment may indicate the login request was authenticated by the bridge controller 410 and the computer device 416 is authorized access to the status information 428. The authentication may include password checks, subscriber privilege checks, and other security checks.

In the embodiment being described, the data network 426 may include an IP network, such as the Internet. The computer device 416 and the user device 402 may be combined in a communication device 430, such as a smart phone or an IP phone. The computer device 416 may be remote in relation to the bridge controller 410.

In still yet another embodiment, the transmitting device 408 may transmit an acknowledgment signal and the unique identifier to the bridge controller 410 in response to receiving the unique identifier. The acknowledgment signal may be an in-band signal with respect to the conference call. The acknowledgment signal may indicate the user device 402 has a hold status feature activated for the conference call.

The communication network 412 may include a wireless communication network, a wire line communication network, a VoIP network, or any suitable combination of such networks. The unique identifier may relate to a port number assigned to the user device 402 for the conference call.

In one embodiment, the user device 402 may also include a storage device 432 in communication with the call processor 406 for storing the unique identifier for reference by the call processor 46 during the conference call in conjunction with transmitting and receiving various in-band signals associated with a hold status feature. In another embodiment, the call processor 406 may determine the user device 402 is about to activate a hold function based on determining user activation of a hold control has occurred, determining user activation of a switching control to switch an active line from a first line to which the conference call is connected to another line, or user activation of another function of the user device that causes the conference call to be placed on hold has occurred.

Each in-band signal described in relation to FIG. 4 may include a pulse tone, a frequency tone, a multi-frequency tone, or any suitable combination of such tones. The various embodiments of the user device 402 described above may be implemented in a user device, such as a mobile station, a wire line telephone, a VoIP device, or any other suitable communication device. The bridge controller 410, although shown outside the communication network 412, may be a component of the communication network 412. The various embodiments of the bridge controller 410 described above may be implemented in any other suitable component of the communication network 412.

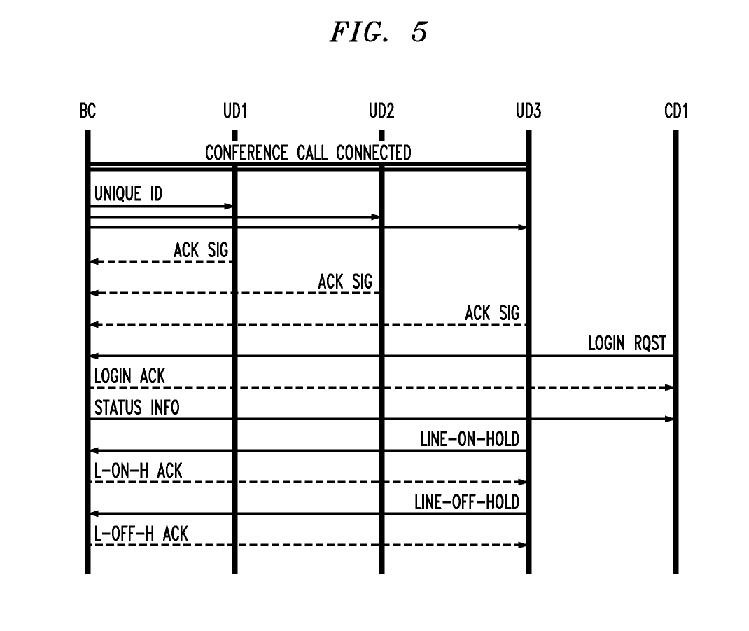

With reference to FIG. 5, an exemplary embodiment of a communication system with a conference bridge may include a bridge controller (BC), a first user device (UD1), a second user device (UD2), a third user device (UD3), and a first computer device (CD1). The first computer device (CD1) may be associated with the first user device (UD1) as described above for devices that are disposed such that a user can monitor participant status on the computer device while participating in the conference call via the user device. The diagram shows that the bridge controller (BC) has connected a conference call between the first, second, and third user devices (UD1-3) via the conference bridge of a communication network. The bridge controller (BC) is also shown connected to the conference call. The call flow diagram shows an exemplary embodiment of signaling for controlling the conference bridge. The dashed lines reflect signaling that is optional.

After the conference call is connected, the bridge controller (BC) may transmit a unique identifier (UNIQUE ID) to each of the first, second, and third user devices (UD1-3). The unique identifier may be transmitted via an in-band signal with respect to the conference call. The bridge controller (BC) may receive an acknowledgment signal (ACK SIG) and the corresponding unique identifier (UNIQUE ID) from at least one user device participating in the conference call. The acknowledgment signal may be an in-band signal with respect to the conference call. The acknowledgment signal indicates the corresponding user device has a hold status feature activated for the conference call. In the embodiment being described the first, second, and third user devices (UD1-3) all have the hold status feature activated and ACK SIGs from all three user devices are shown.

Next, the bridge controller (BC) may receive a login request (LOGIN RQST) from the first computer device (CD1) via a data network requesting status information (STATUS INFO) for the conference call. The status information may maintain a participant status for one or more user devices participating in the conference call. In the embodiment being described, the first, second, and third user devices (UD1-3) all have the hold status feature activated and the status information will include participant status for all three user devices. The bridge controller (BC) may authenticate the login request from the first computer device (CD1) to confirm the first computer device (CD1) is authorized to receive the status information for the conference call. The authentication may include password checks, subscriber privilege checks, and other security checks. The bridge controller (BC) may transmit a login acknowledgment (LOGIN ACK) to the computer device via the data network after the authenticating. The login acknowledgment may indicate the login request was received and the first computer device (CD1) is authorized access to the status information.

At this point, the status information (STATUS INFO) may be provided to the first computer device (CD1) from the bridge controller (BC) via the data network for display to a user on a display device associated with the first computer device (CD1). The status information may be received via a transmission from the bridge controller (BC) to the first computer device (CD1) or retrieved by the first computer device (CD1) from the bridge controller (BC). The initial status information on the display device may be periodically refreshed or updated either manually (e.g., user refresh activated) or automatically. Automatic updates to the status information on the display device may be based on a refresh rate (e.g., time) or on a change to the status information (e.g., hold status change).

Next, the bridge controller (BC) may receive a line-on-hold signal (LINE-ON-HOLD) and the corresponding unique identifier (UNIQUE ID) from the third user device (UD3). The line-on-hold signal may be an in-band signal with respect to the conference call. The bridge controller (BC) may update the status information in response to receiving the line-on-hold signal to indicate the third user device (UD3) has placed the conference call on hold. The bridge controller (BC) may transmit a line-on-hold acknowledgment (L-ON-H ACK) and the corresponding unique identifier (UNIQUE ID) to the third user device (UD3) to acknowledge the line-on-hold signal was received. The line-on-hold acknowledgment may be transmitted via an in-band signal with respect to the conference call.

Next, the bridge controller (BC) may receive a line-off-hold signal (LINE-OFF-HOLD) and the corresponding unique identifier (UNIQUE ID) from the third user device (UD3). The line-off-hold signal may be an in-band signal with respect to the conference call. The bridge controller (BC) may update the status information in response to receiving the line-off-hold signal to indicate the third user device (UD3) has returned to the conference call. The bridge controller (BC) may transmit a line-off-hold acknowledgment (L-OFF-H ACK) and the corresponding unique identifier (UNIQUE ID) to the third user device (UD3) to acknowledge the line-off-hold signal was received. The line-off-hold acknowledgment may be transmitted via an in-band signal with respect to the conference call.

It is understood that the second and third user devices (UD2, UD3) may also have computer devices with which to monitor participant status in the same manner as participant status may be monitored on the first computer device (CD1) by the user of the first user device (UD1). It is also understood that a login request (LOGIN RQST) can be received from any computer device at any time during the conference call. Similarly, it is understood that a line-on-hold signal (LINE-ON-HOLD) can be received from any user device in which the hold status feature is activated at any time during the conference call except when the corresponding user device has already placed the conference call on hold. It is also understood that a line-off-hold signal (LINE-OFF-HOLD) can be received from any user device in which the hold status feature is activated at any time during the conference call after the corresponding user device has placed the conference call on hold. Moreover, it is understood that the line-on-hold signal (LINE-ON-HOLD) and line-off-hold signal (LINE-OFF-HOLD) may in actuality be the same signal because the bridge controller can toggle the hold status for the corresponding user device between on-hold and off-hold.

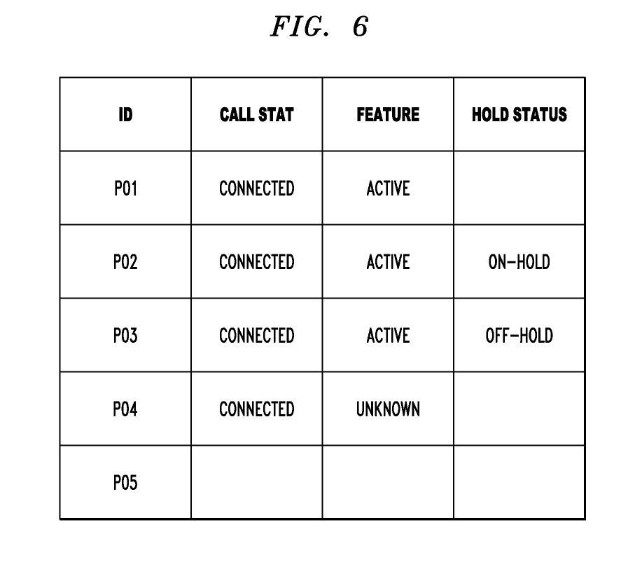

With reference to FIG. 6, an exemplary embodiment of a communication system with a conference bridge may include a bridge controller and five user devices. The bridge controller may connect a conference call between the five user devices via the conference bridge of a communication network. The bridge controller may also be connected to the conference call. The bridge controller may assign unique identifiers to the five user devices, establish status information for the conference call, and store the status information in a storage device. The status information may maintain a participant status for the five user devices during the conference call.

The diagram shows an exemplary embodiment of the status information. The exemplary content and exemplary arrangement includes include a user device identifier column (ID), a call status column (CALL STAT), a feature status column (FEATURE), and a hold status column (HOLD STATUS) for each user device. Alternate content and arrangements of content are contemplated. The unique identifiers assigned to the five user devices are shown in the ID column (i.e., P01, P02, P03, P04, and P05, respectively). As shown, the unique identifiers are related to port numbers assigned to the corresponding user devices. In other embodiments, the unique identifiers can include port number, caller ID numbers, caller ID names, and other identifying information in any suitable combination.

The status information may be arranged such that information entries in the unique identifier column form rows based on user devices participating in the conference call. CALL STAT, for example, may be set to CONNECTED or another suitable term after a user device is accepted and connected to the conference call. After a user device ends the conference call connection, CALL STAT may be left blank (as shown), CONNECTED may be grayed out, set to DISCONNECTED, or set to another suitable term. In another embodiment, the row associated with a user device that ends the conference call connection may be removed from the status information. As shown, the first through fourth user devices (P01-P04) are connected to the conference call and the fifth user device (P05) has ended the conference call connection.

FEATURE, for example, may be set to ACTIVE (as shown) or another suitable term when the bridge controller receives a signal from the corresponding user device that indicates it has a hold status feature activated for the conference call. Receipt of the line-on-hold and acknowledgment signals described above would inform the bridge controller of the ACTIVE condition. Otherwise, the FEATURE may be set to UNKNOWN (as shown) or another suitable term. The FEATURE may be left blank (as shown) after a user device has ended the conference call connection. As shown, the first through third user devices (P01-P03) have the hold status feature activated for the conference call, the bridge controller does not know if the fourth user device (P04) has the hold status feature activated, and the first user device (P05) has ended the conference call connection.

HOLD STATUS, for example, may set to ON-HOLD or another suitable term when the user device has placed the conference call on hold. When a user device that previously placed the conference call on hold has returned, HOLD STATUS may be set to OFF-HOLD or another suitable term. Otherwise, HOLD STATUS may be left blank. As shown, the second user device has placed the conference call on hold, the third user device has returned to the conference call after having placed it on hold, and the HOLD STATUS for the other user devices is blank.

As described above, the status information is stored within a bridge controller or another suitable component of a communication network and provided to a computer device for display to a user on a display device such that the user can monitor participant status while participating in the conference call via a corresponding user device. The status information depicted in FIG. 6 is an exemplary embodiment of the status information 210, 218 (FIGS. 2, 4) stored in a storage device 202 (FIG. 2) and a bridge controller 200, 410 (FIGS. 2, 4) and displayed on a display device 220, 418 (FIGS. 2, 4) of a computer device 216, 416 (FIGS. 2, 4).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for controlling a conference bridge, comprising:
a) establishing status information for a conference call and storing the status information in a storage device, a plurality of user devices connected to the conference call via a communication network, the status information for maintaining a participant status for one or more user devices participating in the conference call;
b) initially setting the status information to indicate each user device participating in the conference call is connected;
c) transmitting a unique identifier to each user device participating in the conference call, wherein the unique identifier is transmitted via an in-band signal with respect to the conference call;
d) receiving a line-on-hold signal and the corresponding unique identifier from at least one user device participating in the conference call, wherein the line-on-hold signal is an in-band signal with respect to the conference call; and
e) updating the status information in response to receiving each line-on-hold signal to indicate the corresponding user device from which the corresponding line-on-hold signal was received has placed the conference call on hold.

2. The method of claim 1, further comprising:
f) receiving a line-off-hold signal and the corresponding unique identifier from at least one user device participating in the conference call from which the line-on-hold signal was received, wherein the line-off-hold signal is an in-band signal with respect to the conference call; and
g) updating the status information in response to receiving each line-off-hold signal to indicate the corresponding user device from which the corresponding line-off-hold signal was received has returned to the conference call.

3. The method of claim 2, further comprising:
h) transmitting a line-off-hold acknowledgment and the corresponding unique identifier to each user device from which the line-off-hold signal was received to acknowledge the corresponding line-off-hold signal was received, wherein the line-off-hold acknowledgment is transmitted via an in-band signal with respect to the conference call.

4. The method of claim 1, further comprising:
f) receiving a login request from a computer device via a data network; and
g) providing the status information to the computer device via the data network for display to a user on a display device.

5. The method of claim 4 wherein the user is participating in the conference call, the corresponding user device for the user and the computer device being disposed such that the user can monitor participant status on the display device of the computer device while participating in the conference call via the corresponding user device.

6. The method of claim 4, further comprising:
h) authenticating the login request from the computer device to confirm the computer device is authorized to receive the status information for the conference call; and
i) transmitting a login acknowledgment to the computer device via the data network after the authenticating, wherein the login acknowledgment indicates the login request was received and the computer device is authorized access to the status information.

7. The method of claim 1, further comprising:
f) receiving an acknowledgment signal and the corresponding unique identifier from at least one user device participating in the conference call, wherein the acknowledgment signal is an in-band signal with respect to the conference call and indicates the corresponding user device has a hold status feature activated for the conference call; and
g) updating the status information in response to receiving each acknowledgement signal to indicate the corresponding user device from which the corresponding acknowledgment signal was received has a hold status feature activated for the conference call.

8. The method of claim 1, further comprising:
f) transmitting a line-on-hold acknowledgment and the corresponding unique identifier to each user device from which the line-on-hold signal was received to acknowledge the corresponding line-on-hold signal was received, wherein the line-on-hold acknowledgment is transmitted via an in-band signal with respect to the conference call.

9. The method of claim 1 wherein each in-band signal includes at least one of a pulse tone, a frequency tone, and a multi-frequency tone.

10. An apparatus for controlling a conference bridge, comprising:
a storage device for storing status information for a conference call, a plurality of user devices connected to the conference call via a communication network, the status information for maintaining a participant status for one or more user devices participating in the conference call;
a processor for controlling a conference call and, in operative communication with the storage device, for establishing the status information and initially setting the status information to indicate each user device participating in the conference call is connected;
a transmitting device in operative communication with the processor for transmitting a unique identifier to each user device participating in the conference call, wherein the unique identifier is transmitted via an in-band signal with respect to the conference call; and
a receiving device in operative communication with the processor for receiving a line-on-hold signal and the corresponding unique identifier from at least one user device participating in the conference call, wherein the line-on-hold signal is an in-band signal with respect to the conference call;
wherein the processor updates the status information in response to receiving each line-on-hold signal to indicate the corresponding user device from which the corresponding line-on-hold signal was received has placed the conference call on hold.

11. The apparatus of claim 10, the receiving device also for receiving a login request from a computer device via a data network;
wherein the processor provides the status information to the computer device via the data network for display to a user on a display device.

12. The apparatus of claim 11 wherein the data network comprises an internet protocol (IP) network.

13. The apparatus of claim 10 wherein the communication network includes at least one of a wireless communication network, a wire line communication network, and a voice over internet protocol (VoIP) network.

14. A method for controlling a conference bridge, comprising:
a) receiving a unique identifier at a user device participating in a conference call from a bridge controller via a communication network, wherein the unique identifier is received via an in-band signal with respect to the conference call, the unique identifier uniquely identifying the user device as a participant of the conference call in relation to other user devices participating in the conference call;
b) determining the user device is about to activate a hold function in relation to the conference call;
c) transmitting a line-on-hold signal and the unique identifier from the user device to the bridge controller in response to the determining in b), wherein the line-on-hold signal is an in-band signal with respect to the conference call; and
d) placing the conference call on hold at the user device after the line-on-hold signal is transmitted.

15. The method of claim 14, further comprising:
e) transmitting a line-off-hold signal and the unique identifier from the user device to the bridge controller in response to the user device de-activating the hold function and returning the user device to the conference call, wherein the line-off-hold signal is an in-band signal with respect to the conference call.

16. The method of claim 15, further comprising:
f) receiving a line-off-hold acknowledgment and the unique identifier from the bridge controller, wherein the line-off-hold acknowledgment is received via an in-band signal with respect to the conference call.

17. The method of claim 14, further comprising:
e) transmitting a login request from a computer device to the bridge controller via a data network; and
f) receiving status information for the conference call from the bridge controller via the data network for display to a user on a display device, the status information maintaining a participant status for one or more user devices participating in the conference call.

18. The method of claim 17 wherein the user is participating in the conference call via the user device, the user device and the computer device being disposed such that the user can monitor participant status on the display device of the computer device while participating in the conference call via the user device.

19. The method of claim 17, further comprising:
g) receiving a login acknowledgment from the bridge controller via the data network, wherein the login acknowledgment indicates the login request was authenticated by the bridge controller and the computer device is authorized access to the status information.

20. The method of claim 14, further comprising:
e) transmitting an acknowledgment signal and the unique identifier from the user device to the bridge controller in response to receiving the unique identifier, wherein the acknowledgment signal is an in-band signal with respect to the conference call and indicates the user device has a hold status feature activated for the conference call.

21. The method of claim 14, further comprising:
e) storing the unique identifier in a storage device for reference by the user device during the conference call in conjunction with transmitting and receiving various in-band signals associated with a hold status feature.

22. The method of claim 14 wherein the determining in b) is based on at least one of determining a first user activation of a hold control has occurred and determining a second user activation of a switching control to switch an active line from a first line to which the conference call is connected to another line.
